(19) United States
(12) Patent Application Publication
(10) Pub. No.: US 2006/0291471 A1
(43) Pub. Date: Dec. 28, 2006

(54) Method terminal and server for transmission of service messages in fixed and/or mobile networks

(76) Inventors: Jorg Heuer, Munchen (DE); Klaus Illgner-Fehns, Munchen (DE); Joachim Laier, Munchen (DE); Ulrich Nies, Koln (DE); Uwe Rauschenbach, Poing (DE); Gerhard Siemens, Borken (DE); Martin Winter, Rosenheim (DE)

Correspondence Address: BELL, BOYD & LLOYD, LLC, P. O. BOX 1135, CHICAGO, IL, 60690-1135, US

(21) Appl. No.: 10/566,740

(22) PCT Filed: Mar. 17, 2005
(86) PCT No.: PCT/EP05/02888

§ 371 Date: Mar. 17, 2006

(30) Foreign Application Priority Data
Mar. 17, 2004 (DE) 10 2004 013 103.1
Mar. 17, 2004 (DE) 10 2004 013 102.3
Mar. 17, 2004 (DE) 10 2004 013 101.5
Mar. 17, 2004 (DE) 10 2004 013 100.7

(51) Int. Cl. H04L 12/28

(52) U.S. Cl. 370/395.5

(57) ABSTRACT

According to the disclosure, various service messages, such as multimedia messages, short messages, Email messges, fax messages, “Voice Mail” messages, “Instant Messaging” messages etc., available or provided in a service center, or generated in a terminal are transmitted between the service center and a terminal, without the terminal having to be embodied as a client with relation to the transmission and processing of the service message, whereby the service message is directly or indirectly transmitted from the service center to a server, embodied as message server, preparing the message using an intermediate server and sent from the above in prepared form, for output on a network specific terminal to the terminal and multimedia message content is transmitted in the reverse direction from the terminal to the server which generates multimedia messages from the content and then sends the above directly or indirectly to the service center.

### FIELD OF TECHNOLOGY

The present disclosure relates to smart-home networking and messaging

### BACKGROUND

Multimedia messages or service messages of various types employed in communication services such as SMS (Short Message Service), MMS (Multimedia Message Service), e-mail (electronic mail), IM (Instant Messaging), and others are typically transmitted on the downlink and uplink between a communication server in the service center and a terminal embodied in the mobile radio network as a mobile telephone (cell phone) and in the circuit-switched and/or packet-switched fixed network as a communication terminal that can be used for this purpose in a “Smart Home” scenario.

As a successor to the very widely disseminated Short Message Service (SMS), mobile radio operators have developed and introduced the Multimedia Message Service (MMS). This is characterized in that images, sound, and text files are transmitted in unison, delivered directly to the recipient, and visualized by the terminal. A prerequisite is for the recipient to have an MMS-enabled terminal. If that is not the case the recipient will be notified accordingly via another route (SMS, telephone call, e-mail, etc.) and at the same time be offered a link to a “URL (Unified Resource Locator)” via which he or she will be able to retrieve the message at a later time using a “WEB browser”.

According to the prior art, a special gateway, in particular an “F-MMS gateway”, and a terminal designed for the service, in particular an MMS-enabled terminal, is required for delivering service messages, in particular “multimedia messages”, to a terminal (for example a DECT telephone) that is not directly connected to the mobile radio system. However, such terminals for fixed networks are only being introduced into, and available on the market gradually. For a swift launch of the various services, in particular the MMS service, in a fixed network it is therefore necessary also to enable users to receive such service messages using any terminals.

According to the prior art a terminal designed for the service, in particular an MMS-enabled terminal, is again necessary for producing service messages, in particular MMS messages. Alongside this, “WEB clients” are also employed on the personal computer for producing messages of said type. So that the above-described reception of service messages, in particular MMS messages, on any terminals can be employed to practical advantage, a concept is also required for producing and sending service messages, in particular MMS messages, on terminals that are not suitable for this purpose.

To enable the individual communication subscribers offered the communication services cited at the beginning to have uniform access to the services and so that data transmitted therein can be administered, it is known that providers of such communication services operate special internet portals such as, for example, “WEB.DE” (http://web.de), and offer them for use. The “WEB.DE” offering comprises a large, editorially maintained directory of German-language internet pages and services relating to navigation, information, communication, discussion, and entertainment. “WEB.DE” moreover also offers what is termed the “Unified Messaging” service which includes, inter alia, an e-mail service, an SMS service, an organizer service (calendar, appointment, and address management), and a telefax service, and further offers the possibility of conducting telephone calls.

### SUMMARY

Accordingly, a method, terminal, and server for transmitting service messages in a fixed and/or mobile network is disclosed, wherein various types of service messages such as, for example, multimedia messages (MMS messages), short messages (SMS messages), e-mail messages, facsimile messages, “voice mail” messages, “Instant Messaging” messages etc. that are available or provided in a service center or generated in the terminal are transmitted between the service center and terminal without the terminal's having to be embodied as a “client” with reference to transmitting and processing the service message.

Different multimedia messages may be transmitted from a service center directly or indirectly, via an intermediate server, to a server embodied as a “message server” which edits the message in accordance with the present disclosure, and forwards them therefrom in edited form for output on a fixed/mobile network-specific terminal to the terminal and, in the opposite direction, to transmit multimedia message content from the terminal to the server, which produces a multimedia message from said content then forwards said message again directly or indirectly to the service center.

The technical features include:
(i) Delivering the multimedia message (service message) to the terminal and processing multimedia content, although the terminal itself does not have a special “client” for understanding and processing the message.
(ii) Provisioning a server which edits the multimedia messages and communicates with the terminal over a packet-switched connection.
(iii) A mechanism which allows a terminal subscriber (for example a person using the terminal) to define, as the sender/recipient, the extent to which he/she wishes to be informed about the receipt of new service messages and to produce the content of notifications about new service messages on a need-oriented basis.
(iv) A concept that allows service messages to be produced on and sent from a terminal which itself does not have a special “client” for producing a service message.

The components include the following functions and characteristics:

Server

Registering, authenticating, authorizing, and administering registered terminal subscribers (senders/recipients).

Accepting incoming service messages using, for example, an SMTP protocol.

Analyzing and structuring incoming messages (from whom, which media, semantic analysis of audio, images, and video—identifying characteristic features to simplify and speed up later locating, filtering, and converting); describing by means of structure information in, for example, MPEG-7 format.

Archiving received messages in personal directories.

Delivering notifications to the terminal about the arrival of new messages in the form of “PUSH” via TCP/IP; alternatively as an SIP notification or, as the case may be, message.

Editing the service message in a form harmonized with the terminal and the terminal subscriber's personal preferences; XSLT transformation based on stored style sheets and, depending on terminal features and personal preferences, a presentation of the message generated from the elements of the received message; producing a presentation in a format that is suitable for the terminal, for example HTML, for a “WEB browser” (alternatively also SMIL, WML, XML, etc.).

Provisioning of control functions such as, for instance, the deletion of messages, implemented using, for example, JavaScripts.

Administering statuses of logged-on terminal subscribers with reference to the retrieval of service messages. This will allow several users of one and the same terminal, for example a set-top box used in conjunction with a television set, to retrieve and manage their personal messages individually.

Accepting message elements from the terminal for sending as an MMS.

Composing an MMS and sending it via SMTP to the MMSC.

Terminal

Can be any terminal and in a specific embodiment is, for example, a set-top box used in conjunction with a television set.

Makes an application available for the purpose of outputting, for example visualizing presentations/media, for example a “WEB browser”.

Implements a communication component, called a notification recipient or “listener”, which accepts the notifications from the server.

It is alternatively also possible for an “SIP client” to be implemented in the terminal.

The “listener” visualizes the notifications, which can contain both text and images, audio, and video components. Visualizing in the form of text, audio data, images, window size, window position, and commands is controlled via an “Application Programming Interface (API)”. The notification recipient can alternatively also forward the received content to the “WEB browser” for visualizing.

The “listener” makes a “Unified Resource Locator (URL)” available to the “WEB browser” via which URL said browser can retrieve the actual message edited for the terminal.

The notification recipient allows an application, for example the browser, to be called up directly from the notification for retrieving the entire message.

The terminal can, as either a “plug-in” or an autonomous application, implement an application for sending messages. Said application conveys the produced/selected information (text, image, audio, video) to the server along with the structure information [for example a form of address, closing phrase, meaning/function of text elements (for example main text, comment, footnote, etc.), and references] which is determined automatically during editing and described in, for example, MPEG-7 format.

Notification:

A particular feature is that the type and scope of the notification (the way the notification message appears) can be individually set by the terminal subscriber. For this purpose he/she informs the server of the required mode during log-on:

Insertion of a window in which are displayed the semantically most important message elements of the received information or, as the case may be, parts of said elements. In the case of a set-top box used in conjunction with a television set the window is inserted over the current TV picture. Both the size of the window and its position on the television screen can vary and should not completely cover the TV screen. The content is extracted from the received service message by the server.

Insertion of information in a status line, with in particular the sender and addressee being displayed. What type of message the service message is constitutes a useful addition if the notification system is used for different service messages.

A result of the status-line solution is that there will be no notification, which is to say that the subscriber will not be disturbed or, as the case may be, interrupted.

The server uses the stored structure information to extract the relevant message elements for the mode that has been set and sends said message elements to the notification recipient in accordance with the mode that has been set.

The components hardware configuration is mostly based on known technologies; special features include component design and combination in a way allowing new functions or, as the case may be, functionalities to be realized in a novel manifestation:

The use of terminals [for example a set-top box, Personal Digital Assistant (PDA), etc.] not designed for a specific communication service for any asynchronous multimedia communication services (SMS, MMS, e-mail, Instant Messaging, chat, etc.).

The delivery of notifications (for example MMS, SMS) does not require a separate circuit-switched connection (for example POTS, ISDN).

Individualized message receipt/delivery can also be realized via a non-personal telephone number/address.

Implementing of a message archive that can administer any messages from any services and display them on any terminals, which do not require a specific “client”.

Retrieval of messages from any terminal, adapted to the terminal's features and to personal preferences.

Uniform access to any asynchronous communication services; no need to implement a separate “client” etc. for each service (SMS, MMS, e-mail, IM, chat).

Description of “transmitting an MMS message” scenario:

A terminal subscriber (subscriber B) purchases a new set-top box and wants to use the “MMS-on-TV” service. To be able to use the service the terminal subscriber first has to register with the server or, as the case may be, server operator. When this is done, an “account” is set up on the server for him/her under which he/she can then log on and retrieve messages. His/her telephone number to which MMS messages would normally be forwarded is also passed on to the “Multimedia Message Service Center (MMSC)” for configuring same.

Subscriber B is at home and watching TV and wants, while doing so, to be notified of the arrival of new messages. His/her set-top box is connected to the “internet” over an existing TCP/IP connection via his/her “Internet Service Provider (ISP)”. The connection can be provided via a modem (POTS, ISDN, for example), xDSL, CableModem, PowerLine, or WLAN, etc.

Subscriber B launches the “WEB browser” via the set-top box's menu and calls up the pre-configured start page for logging on to the server. He/she logs on there using his/her personal password, thereby automatically storing the IP address under which he/she will henceforth be accessible and wants to receive messages. He/she also informs the server of which terminal he/she wishes henceforth to use for receiving and retrieving messages (the set-top box). He/she finally indicates how he/she wishes to be notified of the arrival of new messages (not at all, via a short notice, fully via an Instant Message, etc.)

The server administers this configuration in a database (see table below).

| Telephone | IP address | Account | Account | Notify | Device |
|---|---|---|---|---|---|
| number | of the STB | name | password | mode | profile |
| 08927134322 | 123.45.67.8 | John Doe | Dhsk&7wel! | Full | TV |
| | | Jane Doe | Hksd792HKS | Status | PDA |

The notification recipient program, which, for example, opens a TCP port and listens for events (for example TCP packets) directed at said port, is launched at the same time.

From a mobile telephone (cell phone) or an MMS-enabled fixed-network telephone, another subscriber (subscriber A) then sends an MMS message to subscriber B, who is known in a fixed network and registered there through his/her telephone number.

The MMS message arrives at the operator's “MMSC”, which is configured in such a way that all messages addressed to registered destination telephone numbers (among which is subscriber B's telephone number) will be forwarded to the server. Present-day systems forward an MMS message in the mobile radio network to the destination mobile telephone or to an F-MMSC gateway or an e-mail/WEB portal.

The forwarding mechanism is based on the SMTP protocol, behind which is a standardized mail protocol.

An SMTP server accepts the message on the server and forwards it for message analysis.

The message is here disassembled into its various components (for example images, text, audio, video, presentation scripts, and other data) and the structure analyzed. From the information contained the structural analysis attempts to identify the semantic meaning of individual components (for example comment, form of address, closing phrase, descriptive metadata such as, for example, camera parameters, etc.), but also the cross-referencing between elements (references, for example text refers to an image). This analysis also includes analyzing the media, in particular video data. For example video clips are disassembled into semantically relevant scenes, which are in turn represented by means of individual key images. When the message is retrieved, video clips can thus also be displayed in the form of short video compilations or of individual key images. The same applies to audio clips. The structure information is described and stored in, for example, MPEG-7 format.

The analysis module identifies the recipient using the information contained in the MMS message, either from the telephone number, where applicable with a number extension, and/or from the form of address (greeting), and/or by means of an explicit address entry in the MMS-specific structure information (Note: The MMS message can itself also contain structure information/metadata). The message and its elements are stored in the recipient's personal message archive, with each message being assigned its own subdirectory. For example:

| | | |
|---|---|---|
| Root | → user 1 | → message1 |
| | | → message2 |
| | → user 2 | → message1 |

Because subscriber B is logged on and has set the notification mode to “Full” (see table), a message compositor will produce a notification. For this purpose said compositor receives the most important text components (image, audio, where applicable video) from the analysis module as well as a “Unified Resource Identifier (URI)” under which the entire message can be retrieved.

The message compositor sends the notification, for example as a TCP packet, to the IP address of the set-top box with the port of the notification recipient.

The notification recipient accepts the packet and, since the notification mode is “Full”, opens a “top-level” window on the television screen in which the message components contained are displayed. The notification simultaneously contains details of actions to be initiated when specific keys are actuated.

By pressing the remote control key “OK”, subscriber B can hence go immediately to message retrieval.

The notification recipient for this purpose launches the “WEB browser” and gives it the “URL/URI” from the notification.

The “WEB browser” issues an “http request” with the “URL/URI” contained in the notification.

From the “URL/URI” the server recognizes who wants to retrieve which message. Because subscriber B has specified a set-top box as the terminal, the XSLT transformer produces an HTML presentation of the message from the style-sheet-based configuration profile designed for a television set and from the structure information of the message, with the media elements being “inserted” into the presentation and adjusted to the format.

Said matching of the media elements to the presentation format is performed by a media adapter which scales and rotates images, matches color spaces, and converts formats (the set-top box requires only one decoder for a single format) etc. Modality changes such as, for example, text-to-speech and video-to-still images, etc. can also be realized here.

An image composed of, for example, 4 quadrants is assembled on the set-top box.

An overview of the messages contained in the message archive is produced in the top left quadrant which overview displays which messages have been read or, as the case may be, are unread, and which message is being read. The subscriber can scroll through the list and select messages. This selection function is implemented in JavaScript form and triggers the compilation of a new HTML presentation on the server. The currently opened message is visualized, for example, having a colored background.

The television program in progress is shown scaled in the top right quadrant.

The text portion of the message containing the links to the media is shown in the bottom left quadrant.

The bottom right quadrant shows the currently selected image.

Subscriber B can change between the quadrants using the “right” and “left” cursor keys, with the selected quadrant again being, for example, color-highlighted.

The “up” and “down” cursor keys are used to scroll within a window.

Subscriber B is furthermore able to use supporting functions such as
Full-image display
Delete messages
Send messages (Reply, Forward, Compose new message)
Change the notification mode

These functions are controlled by means of JavaScripts, with new HTML pages being generated accordingly by the server.

Subscriber B can by selecting an application open an editor for producing a message. He/she is presented with a pre-specified structure via a mask. Images, video, and audio can be inserted alongside a text. The media can be “grabbed” from an archive on the set-top box, from a memory card inserted into the box, from the server, or from the program in progress.

The editor conveys the media elements together with the structure information pre-specified by the mask (in, for example, MPEG-7) to the server (using, for example, the http protocol), which generates a valid MMS message therefrom. This is then forwarded to the “MMSC” for sending.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 shows a first scenario for transmitting different service messages between service centers and terminals located in a “Smart Home” scenario based on a “one-server concept”;

FIG. 2 shows a second scenario for transmitting different service messages between service centers and terminals located in a “Smart Home” scenario based on a “two-server concept”;

FIG. 3 shows, proceeding from FIG. 2, a modified “two-server concept” wherein a server and a terminal in the “Smart Home” scenario form a structural and functional unit;

FIGS. 4a and 4b are a first flowchart for transmitting a service message according to the “one-server concept” shown in FIG. 1;

FIGS. 5a and 5b are a second flowchart for transmitting a service message according to the “two-server concept” shown in FIG. 2;

FIG. 6 is a change-of-state diagram with a top-down approach for transmitting a service message on the downlink (service center→terminal) according to the flow shown in FIGS. 4a and 4b for the “one-server concept” (FIG. 1);

FIG. 7 is a change-of-state diagram with a top-down approach for transmitting a service message on the uplink (terminal→service center) according to the flow shown in FIGS. 4a and 4b for the “one-server concept” (FIG. 1);

FIG. 8 is a change-of-state diagram with a top-down approach for transmitting a service message on the downlink (service center→terminal) according to the flow shown in FIGS. 5a and 5b for the “two-server concept” (FIG. 2);

FIG. 9 is a change-of-state diagram with a top-down approach for transmitting a service message on the uplink (terminal→service center) according to the flow shown in FIGS. 5a and 5b for the “two-server concept” (FIG. 2);

FIG. 10 shows the basic structure of the server in FIG. 1 and of the second server in FIGS. 2 and 3 for transmitting a service message on the downlink (service center→terminal);

FIG. 11 shows the basic structure of the server in FIG. 1 and of the second server in FIGS. 2 and 3 for transmitting a service message on the uplink (terminal→service center);

FIG. 12 shows the basic structure of the terminal (set-top box, television set, and remote control) in FIGS. 1 to 3 for transmitting a service message in accordance with a first transmission protocol HTTP-over-TCP/IP; and

FIG. 13 shows the basic structure of the terminal (set-top box, television set, and remote control) in FIGS. 1 to 3 for transmitting a service message in accordance with a second transmission protocol SIP, HTTP-over-TCP/IP.

### DETAILED DESCRIPTION

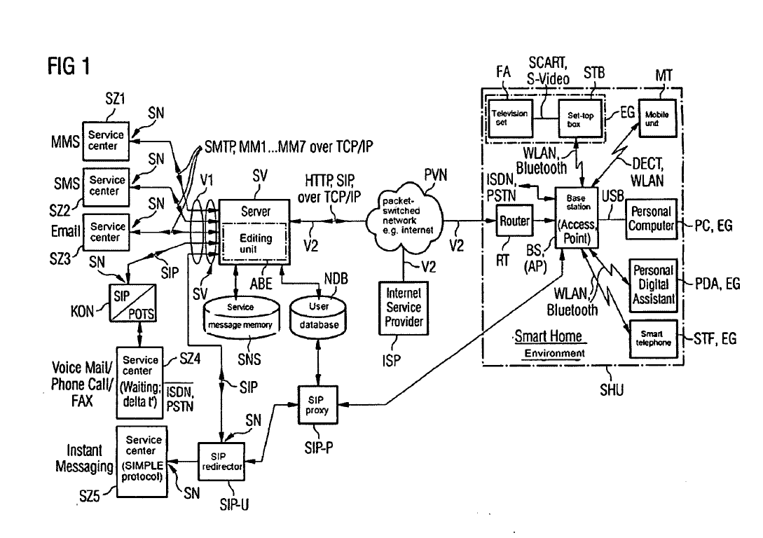

FIG. 1 shows a first embodiment for transmitting different service messages SN between service centers SZ1 . . . SZ5 and terminals EG located in a “Smart Home” scenario SHU. Of the service centers SZ1 . . . SZ5 a first service center SZ1 is embodied for transmitting the “Multimedia Message Service (MMS)” as a “Multimedia Message Service Center (MMSC)”, a second service center SZ2 is embodied for handling the “Short Message Service (SMS)” as a “Short Message Service Center (SMSC)”, a third service center SZ3 is embodied for handling the “e-mail” Service as an “Electronic Mail Service Center (EMail SC)”, a fourth service center SZ4 is embodied for handling the “Voice Mail/Phone Call/Fax” service as a “Voice Mail/Phone Call/Fax Service Center (Voice Mail/Phone Call/Fax SC”, and a fifth service center is embodied for handling the “Instant Messaging” service” as an “Instant Messaging Service Center (IMSC)”.

Of the service centers SZ1 . . . SZ5, the first service center SZ1, the second service center SZ2, and the third service center SZ3 are each connected via a first packet-switched connection V1 to a server SV. A server/service center-specific transmission protocol SMTP, MM1 . . . MM7-over-TCP/IP is handled via said first connection V1 between the respective service center SZ1 . . . SZ3 and the server SV. The transmission protocol is preferably a “Simple Mail Transfer Protocol (SMTP)” or MMS-specific protocol specified by the “3GPP” standardizing body based on MMS interfaces MM1 . . . MM7 which in either case is handled in the course of a “Transmission Control Protocol/Internet Protocol (TCP/IP)”. Although the packet-switched connection is basically present again between the server SV and the respective service center SZ4, SZ5 when service messages are transmitted according to the “Voice Mail/Phone Call/Fax” service and the “Instant Messaging” service, additional measures or, as the case may be, components are required to be able to control the respectively cited service with the aid of the server SV.

Various protocols are used for the “Instant Messaging” service all of which have in common that it is assumed that the terminal EG is ready to receive and the IM messages can be delivered immediately. The IM message is generally not stored or may be the responsibility of the “client” installed on the terminal EG. A preferred implementation of the “Instant Messaging” service is based on the server SV being configured as a “Session Initiation Protocol (SIP)” server having an SIP-based User Authentication and on the SIMPLE protocol based on the “Session Initiation Protocol” being used. Arriving IM messages are routed to the server SV, which terminates the SIP session, via an SIP redirector SIP-U embodied as an “SIP redirect server”. If the terminal EG has an “IM client” based on the SIMPLE protocol, the terminal subscriber will also be able to use the “Instant Messaging” service directly.

In the case of the “Voice Mail/Phone Call/Fax” service, regular telephone calls conducted over, for instance, a circuit-switched network ISDN, PSTN (Integrated Services Digital Network, Public Switched Telephone Network) will, if a call is not answered, be switched to a converter KON, embodied as a “gateway”, which will accept the call and convert it into an “SIP call”. For that purpose the converter has a POTS (Plain Old Telephone Service) interface and an SIP interface. Said “SIP call” is terminated by the server SV in the form of an SIP-based answering machine which stores the voice mail as a message in the archive and notifies the terminal subscriber of the voice mail's arrival. Fax messages are also accepted and forwarded to the server SV in an analogous manner.

The server SV at which the service messages SN transmitted by the service centers SZ1 . . . SZ5 arrive has, for processing said service messages SN, an editing unit ABE that is connected to a service message memory SNS. Besides the service message memory SNS the editing unit ABE is also assigned a user database NDB that is also used by an “SIP proxy” SIP-P. The service message memory SNS and/or the user database NDB are/is either located outside the server SV or form/forms a constituent part thereof.

The “SIP proxy” SIP-P is preferably located in a “client-server architecture” between the “client” and server. In FIG. 1 the “client” is the terminal EG in the “Smart Home” scenario SHU, while the server is formed from the SIP redirector SIP-U in conjunction with the server SV or from the SIP redirector SIP-U in conjunction with the service center SZ5.

The server SV is assigned via a second packet-switched connection V2 to a packet-switched network PVN embodied preferably as the internet. Via the second connection V2 the packet-switched network PVN is furthermore assigned an “Internet Service Provider” ISP and a router RT in the “Smart Home” scenario SHU as a coupling module for coupling the terminal EG to the packet-switched network PVN. The data or, as the case may be, information transmitted over the second packet-switched connection V2 between the router RT, the “Internet Service Provider” ISP, and the server SV is transmitted in accordance with a server-/terminal-specific transmission protocol HTTP, SIP-over-TCP/IP. The cited transmission protocol is preferably a “HyperText Transfer Protocol (HTTP)” or “Session Initiation Protocol (SIP)” handled in each case in the course of the “Transmission Control Protocol/Internet Protocol (TCP/IP)”.

In the “Smart Home” scenario SHU a cordless base station BS embodied as an “Access Point (AP)” is connected between the router RT and the respective terminal EG. The base station BS has a connection to an ISDN/PSTN-specific circuit-switched network and a connection to the “SIP proxy” SIP-P. Via a DECT/WLAN air interface, the base station BS is furthermore assigned a conventional cordless mobile unit MT for circuit-switched cordless telephony. Besides the mobile unit MT, the base station BS is also assigned a multiplicity of potential terminals EG. For example a set-top box STB connected to a television set FA via SCART or S-video interface, a personal computer PC, a “Personal Digital Assistant” PDA, and a smart telephone STF are embodied in the “Smart Home” scenario SHU as a terminal EG. While the set-top box STB, the “Personal Digital Assistant” PDA, and the smart telephone STF are each connected to the base station BS via a short-range radio interface embodied preferably according to the IEEE 802.11 standard (WLAN standard) or Bluetooth standard, the personal computer PC is connected to the base station BS via a USB port.

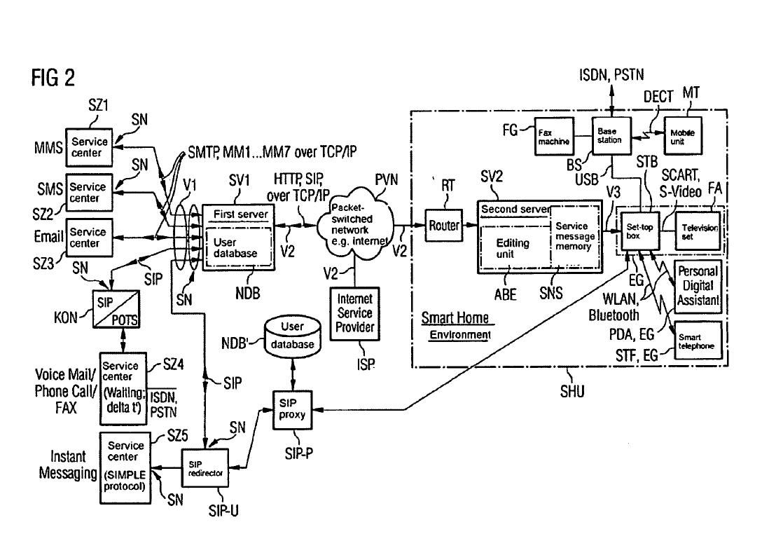

FIG. 2 illustrates a second embodiment for transmitting different service messages SN between service centers SZ1 . . . SZ5 and terminals EG located in a “Smart Home” scenario SHU. Again, of the service centers SZ1 . . . SZ5 a first service center SZ1 is embodied for transmitting the “Multimedia Message Service (MMS)” as a “Multimedia Message Service Center (MMSC)”, a second service center SZ2 is embodied for handling the “Short Message Service (SMS)” as a “Short Message Service Center (SMSC)”, a third service center SZ3 is embodied for handling the “e-mail” service as an “Electronic Mail Service Center (EMail SC)”, a fourth service center SZ4 is embodied for handling the “Voice Mail/Phone Call/Fax” service as a “Voice Mail/Phone Call/Fax Service Center (Voice Mail/Phone Call/Fax SC”, and a fifth service center is embodied for handling the “Instant Messaging” service” as an “Instant Messaging Service Center (IMSC)”.

Of the service centers SZ1 . . . SZ5 the first service center SZ1, the second service center SZ2, and the third service center SZ3 are again each connected via a first packet-switched connection V1 to a first server SV1. A server/service center-specific transmission protocol SMTP, MM1 . . . MM7-over-TCP/IP is again handled via said first connection V1 between the respective service center SZ1 . . . SZ3 and the first server SV1. The transmission protocol is again preferably a “Simple Mail Transfer Protocol (SMTP)” or MMS-specific protocol specified by the “3GPP” standardizing body based on MMS interfaces MM1 . . . MM7 which in either case is handled in the course of a “Transmission Control Protocol/Internet Protocol (TCP/IP)”. Although the packet-switched connection is basically present again between the first server SV1 and the respective service center SZ4, SZ5 when service messages are transmitted according to the “Voice Mail/Phone Call/Fax” service and the “Instant Messaging” service, additional measures or, as the case may be, components are required to be able to control the respectively cited service with the aid of the first server SV1.

Various protocols are used for the “Instant Messaging” service all of which have in common that it is assumed that the terminal EG is ready to receive and the IM messages can be delivered immediately. The IM message is as a rule not stored or, as the case may be, said function is the responsibility of the “client” installed on the terminal EG. A preferred implementation of the “Instant Messaging” service is based on the first server SV1 being configured as a “Session Initiation Protocol (SIP)” server having an SIP-based User Authentication and on the SIMPLE protocol based on the “Session Initiation Protocol” being used. Arriving IM messages are routed to the first server SV1, which terminates the SIP session, via an SIP redirector SIP-U embodied as an “SIP redirect server”. If the terminal EG has an “IM client” based on the SIMPLE protocol, the terminal subscriber will also be able to use the “Instant Messaging” service directly.

In the case of the “Voice Mail/Phone Call/Fax” service, regular telephone calls conducted over, for instance, a circuit-switched network ISDN, PSTN (Integrated Services Digital Network, Public Switched Telephone Network) will, if a call is not answered, be switched to a converter KON, embodied as a “gateway”, which will accept the call and convert it into an “SIP call”. For that purpose the converter has a POTS (Plain Old Telephone Service) interface and an SIP interface. Said “SIP call” is terminated by the first server SV in the form of an SIP-based answering machine which stores the voice mail as a message in the archive and notifies the terminal subscriber of the voice mail's arrival. Fax messages are also accepted and forwarded to the first server SV in an analogous manner.

In contrast to the server SV in FIG. 1, the server SV at which the service messages SN transmitted by the service centers SZ1 . . . SZ5 arrive is conventionally designed for processing said service messages SN. It therefore does not have an editing unit ABE. Furthermore, the first server SV1 is only assigned a user database NDB and not a service message memory. Besides this, the user database NDB forms a constituent part of the first server SV1. There is, moreover, a further user database NDB′ which is used by an “SIP proxy” SIP-P.

The “SIP proxy” SIP-P is located in a “client-server architecture” between the “client” and server. In FIG. 2 the “client” is again the terminal EG in the “Smart Home” scenario SHU, while the server is formed from the SIP redirector SIP-U in conjunction with the first server SV1 or from the SIP redirector SIP-U in conjunction with the service center SZ5.

The first server SV1 is again assigned via a second packet-switched connection V2 to a packet-switched network PVN embodied preferably as the internet. Via the second connection V2 the packet-switched network PVN is again furthermore assigned an “Internet Service Provider” ISP and a router RT in the “Smart Home” scenario SHU as a coupling module for coupling the terminal EG to the packet-switched network PVN. The data or, as the case may be, information transmitted over the second packet-switched connection V2 between the router RT, the “Internet Service Provider” ISP, and the server SV is transmitted in accordance with a server-/terminal-specific transmission protocol HTTP, SIP-over-TCP/IP. The cited transmission protocol is preferably a “HyperText Transfer Protocol (HTTP)” or “Session Initiation Protocol (SIP)” handled in each case in the course of the “Transmission Control Protocol/Internet Protocol (TCP/IP)”.

In contrast to FIG. 1, a second server SV2, for example a home server, is located in the “Smart Home” scenario SHU between the router RT and the respective terminal EG (two-server concept in contrast to the one-server concept in FIG. 1). Like the server in FIG. 1, the second server SV2 again has an editing unit ABE that is connected to a service message memory SNS located in the second server SV2. In contrast to the server in FIG. 1, the second server SV2 is not, though, assigned a user database NDB. Connected downstream of the second server SV2 via a third connection V3 is a set-top box STB embodied as an “Access Point (AP)”. The set-top box STB has, for example, a USB link to a cordless base station BS that is in turn connected to an ISDN-/PSTN-specific circuit-switched network. The set-top box STB further has a connection to the “SIP proxy” SIP-P. Via a DECT/WLAN air interface said base station BS is furthermore connected to a conventional cordless mobile unit MT for circuit-switched cordless telephony and to a fax machine FG.

Finally, the set-top box STB is connected to a plurality of potential terminals EG, that is to say a “Personal Digital Assistant” PDA and a smart telephone STF. The connection between the set-top box STB and the cited terminals is again based preferably on a short-range radio interface embodied according to the IEEE 802.11 standard (WLAN standard) or Bluetooth standard. The set-top box STB is additionally connected to a television set FA via a SCART or S-Video interface, with the set-top box STB and television set FA forming a further terminal EG.

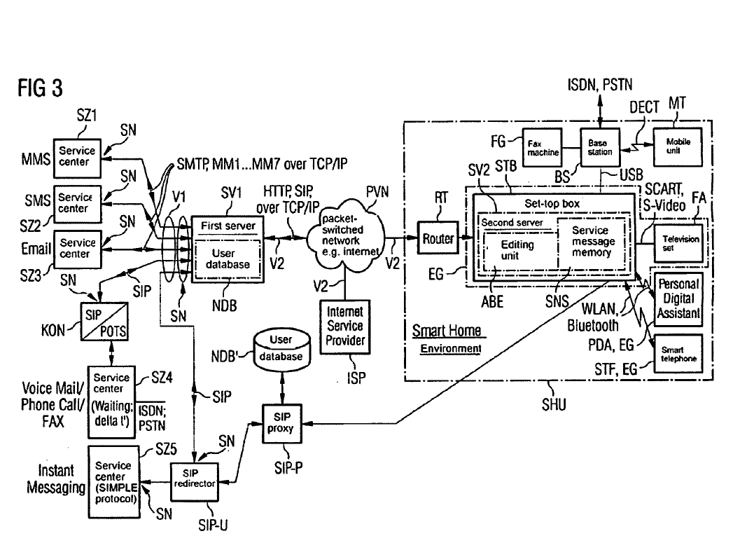

FIG. 3 shows a third scenario for transmitting different service messages SN between service centers SZ1 . . . SZ5 and terminals EG located in a “Smart Home” scenario SHU which differs from the second scenario according to FIG. 2 only in that the second server SV2, with all its functionalities, is a constituent part of the set-top box STB. The integrating of units having different functionalities can be advanced to such an extent, for example, that the router RT is also a constituent part of the set-top box STB.

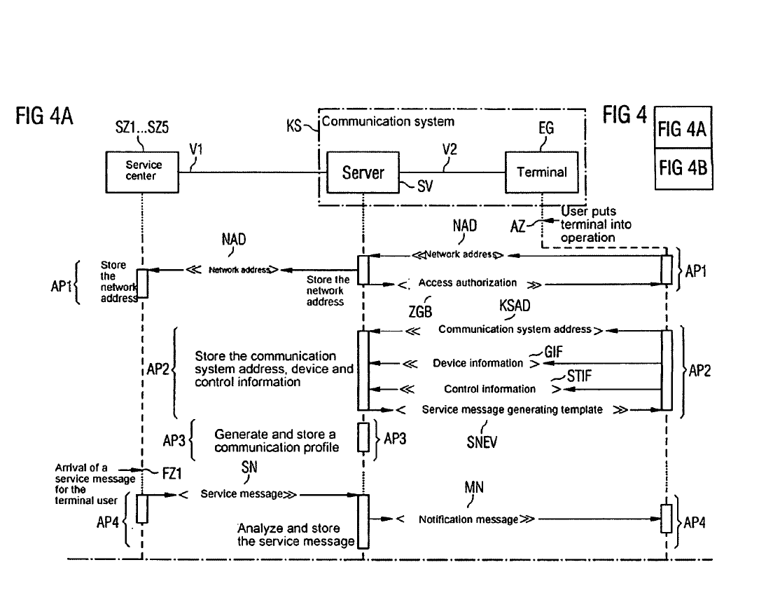

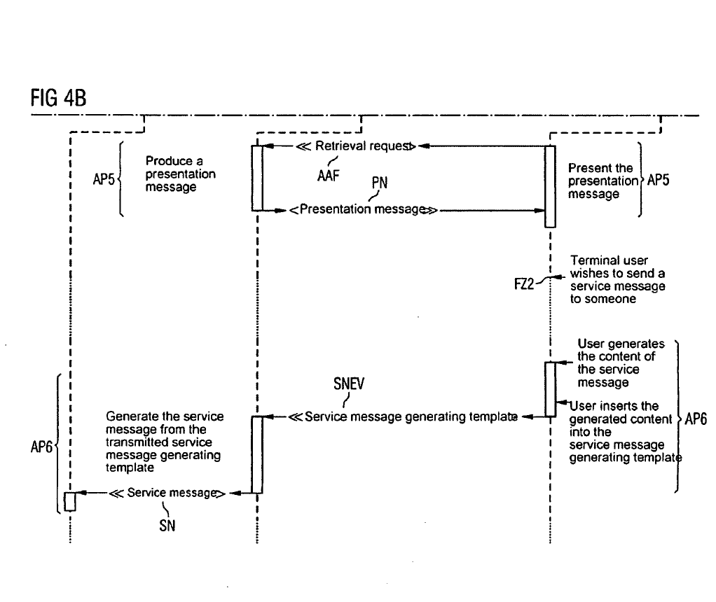

FIGS. 4a and 4b show a first flowchart having a plurality of flow phases AP1 . . . AP6 for transmitting a service message SN according to the “one-server concept” shown in FIG. 1, in which concept the service center SZ1 . . . SZ5 is connected via the first connection V1 to the server SV and in which concept the server SV is connected via the second connection V2 to the terminal EG and together with the terminal EG forms a communication system KS.

In an initial status AZ the terminal EG is put into operation by a user. In a directly ensuing first flow phase AP1 a network address NAD containing, for example, a telephone number or e-mail address is transmitted from the terminal EG to the server SV for registering the terminal EG with the server SV. The server SV stores the network address NAD and forwards it to the service center SZ1 . . . SZ5, where the network address NAD is likewise stored.

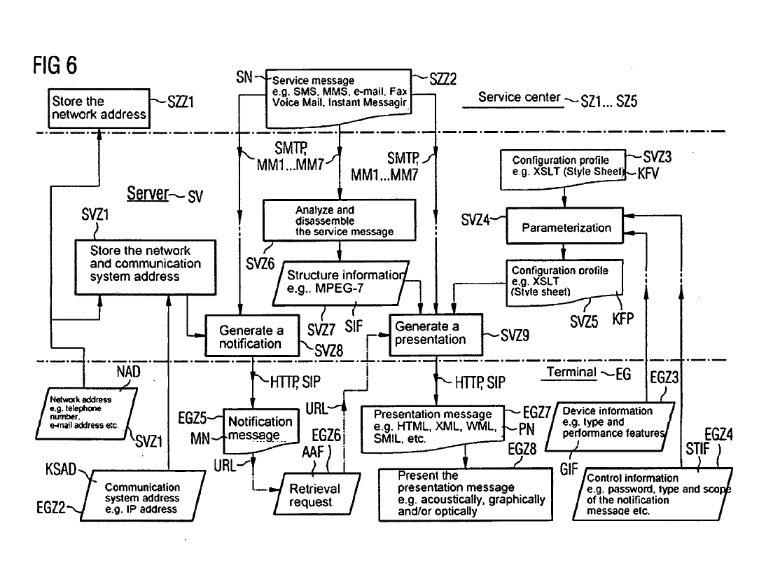

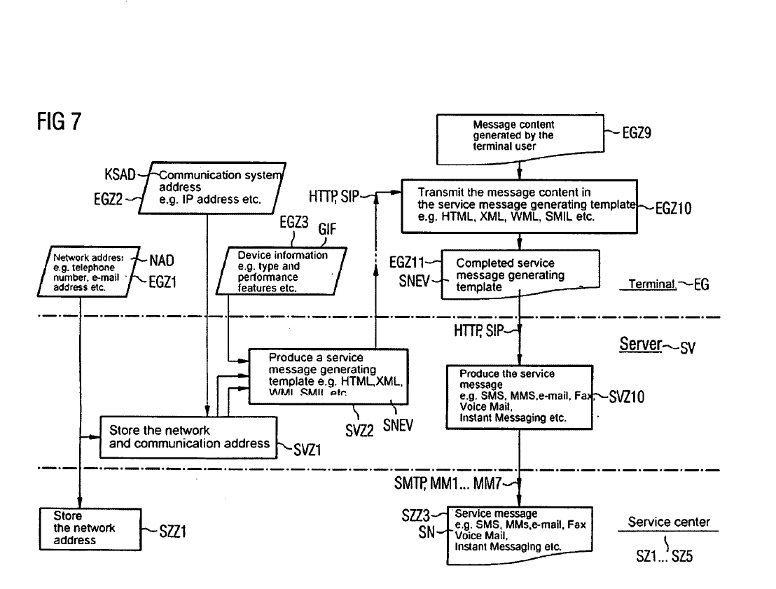

This is shown in the respective change-of-state diagram in FIGS. 6 and 7 by the transition from a first EG status (terminal status) “Network address NAD, for example telephone number, e-mail address etc.” EGZ1 to a first SV status (server status) “Storing the network address and communication system address” SVZ1 and a first SZ status (service center status) “Storing the network address” SZZ1.

On receiving the network address NAD, server SV responds by transmitting an access authorization ZGB to the terminal EG.

The terminal EG logs on to the server SV in a directly ensuing second flow phase AP2. For this purpose said terminal transmits a communication system address KSAD containing, for example, an IP address, device information GIF comprising, for example, type or features, and control information STIF, comprising, for example, a password or the type and scope of a notification message, to the server SV. The server SV stores the communication system address KSAD and the device and control information GIF, STIF and transmits a service message generating template SNEV to the terminal EG which template is presented, for example, in different formats such as “HyperText Markup Language (HTML)”, “EXtensible Markup Language (XML)”, “WAP (Wireless Application Protocol) Markup Language (WML)” or “Synchronized Multimedia Integration Language (SMIL)”.

This is also shown or, as the case may be, indicated, substantially excepting obvious individual storage operations, in the change-of-state diagrams in FIGS. 6 and 7 by the transitions from a second EG status “Communication system address KSAD, for example an IP address etc.” EGZ2 to the first SV status “Storing the network address and communication system address” SVZ1, from a third EG status “Device information GIF, for example type and features etc.” EGZ3 to the server SV or, as the case may be, to a second SV status “Producing a service message generating template SNEV, for example HML, XML, WML, SMIL, etc.” SVZ2, from a fourth EG status “Control information STIF, for example a password, the type and scope of the notification message etc.” EGZ4 to the server SV, and from the second SV status “Producing a service message generating template SNEV, for example HML, XML, WML, SMIL, etc.” SVZ2 to the terminal EG.

In a third flow phase AP3 the server SV uses the received information GIF, STIF to generate a configuration profile which is stored by the server SV.

How the configuration profile is generated is shown, substantially excepting obvious individual storage operations, in the change-of-state diagram in FIG. 6 by the transitions from a third SV status “Communication template KFV, for example XSLT (style sheet)” SVZ3 (EXtensible Style Sheet Language Transformation) to a fourth SV status “Parameterizing” SVZ4, and from the fourth SV status “Parameterizing” SVZ4, taking account of the device and control information GIF, STIF (transitions of the EG statuses EGZ3, EGZ4 to the server SV) transmitted from the terminal EG to the server SV, to a fifth SV status “Communication profile KFP, for example XSLT (style sheet)” SVZ5.

The configuration profile KFP is consequently the result of parameterizing the configuration template KFV by means of the device and control information GIF, STIF.

In a first follow-on status FZ1 a service message SN arrives in the service center SZ1 . . . SZ5 for the user of the terminal EG. In a fourth flow phase AP4 the service center SZ1 . . . SZ5 thereupon transmits the service message SN to the server SV for example in accordance with the server/service center-specific transmission protocol SMTP, MM1 . . . MM7. The received service message SN is analyzed and stored in the server SV. The server SV then transmits a notification message MN to the terminal EG informing the terminal EG that a service message SN intended for the terminal EG is in the server SV and can be collected. For this purpose the notification message MN contains a “Unified Resource Location (URL)”.

This is also shown, substantially excepting obvious individual storage operations, in the change-of-state diagram in FIG. 6 by the transitions from a second SZ status “Service message SN, for example SMS, MMS, e-mail, fax, voice mail, Instant Messaging etc.” SZZ2 to the server SV, from the second SZ status “Service message SN, for example SMS, MMS, e-mail, fax, voice mail, Instant Messaging etc.” SZZ2 to a sixth SV status “Analyzing and disassembling the service message” SVZ6, from the sixth SV status “Analyzing and disassembling the service message” SVZ6 to a seventh SV status “Structure information SIF, for example MPEG-7” SVZ7, from the second SZ status “Service message SN, for example SMS, MMS, e-mail, fax, voice mail, Instant Messaging etc.” SZZ2 to an eighth SV status “Producing a notification” SVZ8, from the first SV status “Storing the network address and communication system address” SVZ1 to the eighth SV status “Producing a notification” SVZ8, and from the eighth SV status “Producing a notification” SVZ8 to a fifth EG status “Notification message MN” EGZ5.

The service message stored in the server SV is disassembled into its individual components during analyzing and disassembling in the sixth SV status SVZ6 and the structure of the message and/or the semantic meaning of the individual components analyzed. The results of said analysis are then compiled into structure information SIF, preferably in MPEG-7 format, and stored. In parallel with the above-described analysis, a notification is generated in the eighth SV status SVZ8 concerning the service message's arrival in the server SV, where applicable (as an additional option) also taking account of individual message content, after which the notification message MN is transmitted with the “Unified Resource Location (URL)” to the relevant terminal EG in accordance with the network address and communication system address NAD, KSAD stored in the server.

In a directly ensuing fifth flow phase AP5 the terminal EG transmits a retrieval request AAF to the server SV to collect the service message SN stored in the server SV. On receiving said retrieval request AAF the server SV edits the stored service message SN for outputting and presenting the message content on the terminal EG and, for this purpose, produces a presentation message PN that is presented, for example, in different formats such as “HyperText Markup Language (HTML)”, “EXtensible Markup Language (XML)”, “WAP (Wireless Application Protocol) Markup Language (WML)” or “Synchronized Multimedia Integration Language (SMIL)” and which it transmits to the terminal EG in accordance with the server-/terminal-specific transmission protocol HTTP, SIP. After receiving the presentation message PN the terminal EG presents said presentation message PN acoustically, graphically, and/or optically.

This is also shown or, as the case may be, indicated, substantially excepting obvious individual storage operations, in the change-of-state diagram in FIG. 6 by the transitions from the fifth EG status “Notification message MN” EGZ5 to a sixth EG status “Retrieval request AAF” EGZ6, from the sixth EG status “Retrieval request AAF” EGZ6 to a ninth SV status “Generating a presentation” SVZ9, from the seventh SV status “Structure information SIF, for example MPEG-7” SVZ7 to the ninth SV status “Generating the presentation” SVZ9, from the fifth SV status “Configuration profile KFP, for example XSLT (style sheet)” SVZ5 to the ninth SV status “Generating the presentation” SVZ9, from the ninth SV status “Generating a presentation” SVZ9, taking account of the service message SN transmitted from the service center SZ1 . . . SZ5 to the server SV (transition of the SZ status SZZ2 to the server SV), to a seventh EG status “Presentation message PN, for example HTML, XML, WML, SMIL etc.” EGZ7, and from the seventh EG status “Presentation message PN, for example HTML, XML, WML, SMIL etc.” EGZ7 to an eighth EG status “Presenting the presentation message, for example acoustically, graphically, and/or optically” EGZ8. When the terminal EG has transmitted the retrieval request AAF to the server SV for collecting the service message SN, a presentation is generated in the ninth SV status SVZ9 from the stored service message SN by means of the configuration profile KFP and the structure information SIF, after which the presentation message PN is transmitted to the terminal EG, where said message is presented acoustically, graphically, and/or optically.

In a second follow-on status FZ2 the user of the terminal EG wishes to send someone (for example a distant mobile radio subscriber) a service message SN. In a sixth flow phase AP6 the user of the terminal EG first generates the content of said service message then inserts the generated content into the service message generating template SNEV received from the server SV during the log-on phase. If the service message generating template SNEV is not available to the user at this time, which may certainly be the case if, as a possible alternative to the case shown in FIGS. 4a and 4b, the service message generating template SNEV has not been transmitted during the second flow phase AP2 (log-on phase) of the terminal, then the service message generating template SNEV must be requested separately from the terminal EG. The completed service message generating template SNEV will be conveyed to the server SV when the user has inserted the generated content into the service message generating template SNEV. In the sixth flow phase AP6 the server SV generates the service message SN from the conveyed service message generating template SNEV and transmits said message to the service center SZ1 . . . SZ5 for the purpose of conveying the message to the distant mobile radio subscriber.

This is also shown or, as the case may be, indicated, substantially excepting obvious individual storage operations, in the change-of-state diagram in FIG. 7 by the transitions from a ninth EG status “Message content generated by the user of the terminal” EGZ9 to a tenth EG status “Transferring the message content to the service message generating template, for example HTML, XML, WML, SMIL etc.” EGZ10, from the tenth EG status “Transferring the message content to the service message generating template, for example HTML, XML, WML, SMIL etc.” EGZ10, taking account of the service message generating template SNEV transmitted from the server SV to the terminal EG (transition of the SV status SVZ2 to the terminal) to an eleventh EG status “Completed service message generating template” EGZ11, from the eleventh EG status “Completed service message generating template” EGZ11 to a tenth SV status “Producing the service message SN, for example SMS, MMS, e-mail, fax, voice mail, Instant Messaging etc.” SVZ10, and from the tenth SV status “Producing the service message SN, for example SMS, MMS, e-mail, fax, voice mail, Instant Messaging etc.” SVZ10 to a third SZ status “Service message SN, for example SMS, MMS, e-mail, fax, voice mail, Instant Messaging etc.” SZZ3.

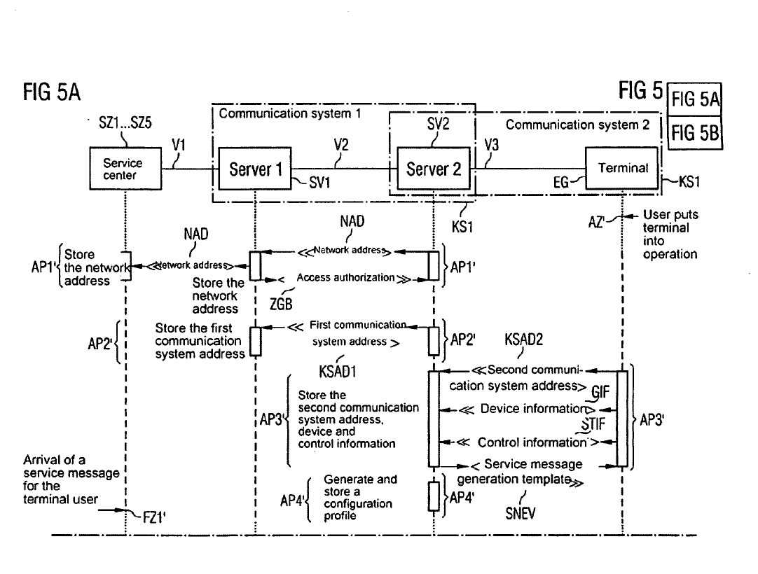

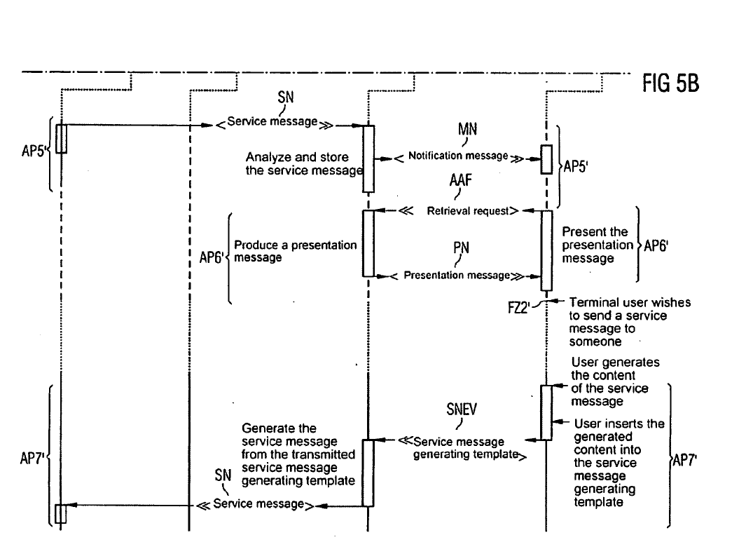

FIGS. 5a and 5b show a second flowchart having a plurality of flow phases AP1′. . . AP7′ for transmitting a service message SN according to the “two-server concept” shown in FIG. 2, in which concept the service center SZ1 . . . SZ5 is connected via the first connection V1 to the first server SV1 and in which concept the first server SV1 is connected via the second connection V2 to the second server SV2 and together with the second server SV2 forms a first communication system KS1, and in which concept the second server SV2 is connected via the third connection V3 to the terminal EG and together with the terminal EG forms a second communication system KS2.

In an initial status AZ′ the second server SV2 and the terminal EG are put into operation by a user. In a directly ensuing first flow phase AP1′ a network address NAD containing, for example, a telephone number or e-mail address is transmitted from the second server SV2 to the first server SV1 for registering the second server SV2 with the first server SV1. The first server SV1 stores the network address NAD and forwards it to the service center SZ1 . . . SZ5, where the network address NAD is likewise stored.

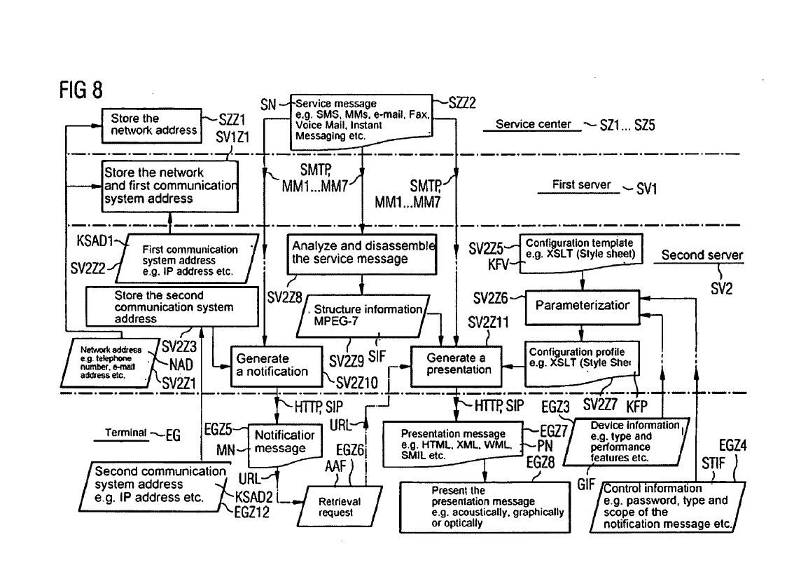

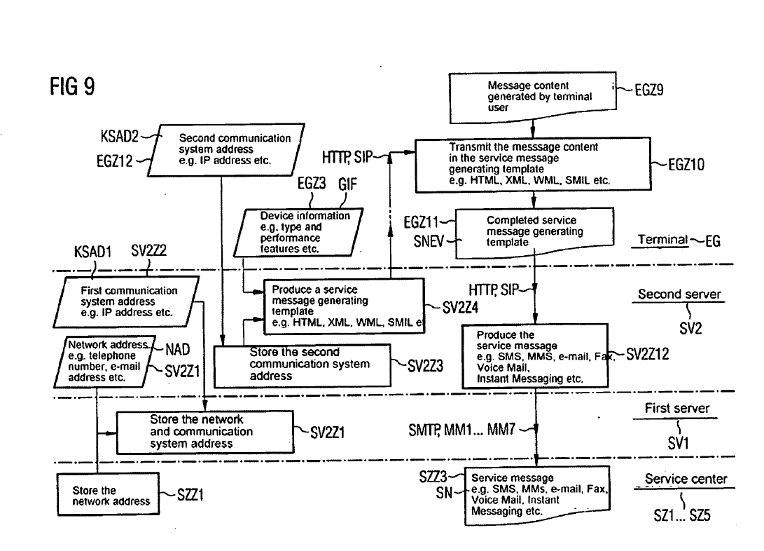

This is shown in the respective change-of-state diagram in FIGS. 8 and 9 by the transition from a first SV2 status (server-2 status) “Network address NAD, for example telephone number, e-mail address etc.” SV2Z1 to a first SV1 status (server-1 status) “Storing the network address and first communication system address” SV1Z1 and a first SZ status (service center status) “Storing the network address” SZZ1.

On receiving the network address NAD, the first server SV1 responds by transmitting an access authorization ZGB to the second server SV2.

The second server SV2 logs on to the first server SV1 in a directly ensuing second flow phase AP2′. For this purpose the second server transmits a first communication system address KSAD1 containing, for example, an IP address to the first server SV1. The first server SV stores the first communication system address KSAD1.

This is shown in the respective change-of-state diagram in FIGS. 8 and 9 by the transition from a second SV2 status “First communication system address KSAD1, for example IP address etc.” SV2Z2 to the first SV1 status “Storing the network address and first communication system address” SV1Z1.

The terminal EG logs on to the second server SV2 in a then ensuring third flow phase AP3′. For this purpose said terminal transmits a second communication system address KSAD2 containing, for example, an IP address, device information GIF comprising, for example, type or features, and control information STIF, comprising, for example, a password or the type and scope of a notification message, to the second server SV2. The second server SV2 stores the second communication system address KSAD2 and the device and control information GIF, STIF and transmits a service message generating template SNEV to the terminal EG which template is presented, for example, in different formats such as HyperText Markup Language (HTML)”, “EXtensible Markup Language (XML)”, “WAP (Wireless Application Protocol) Markup Language (WML)” or “Synchronized Multimedia Integration Language (SMIL)”.

This is also shown, substantially excepting obvious individual storage operations, in the change-of-state diagrams in FIGS. 8 and 9 by the transitions from a twelfth EG status “Second communication system address KSAD2, for example IP address etc.” EGZ12 to a third SV2 status “Storing the second communication system address” SV2Z3, from the third EG status “Device information GIF, for example type and features etc.” EGZ3 to the second server SV2 or, as the case may be, to a fourth SV2 status “Producing a service message generating template SNEV, for example HML, XML, WML, SMIL, etc.” SV2Z4, from the fourth EG status “Control information STIF, for example a password, the type and scope of the notification message etc.” EGZ4 to the second server SV2, and from the fourth SV2 status “Producing a service message generating template SNEV, for example HML, XML, WML, SMIL, etc.” SV2Z4 to the terminal EG.

In a fourth flow phase AP4′ the second server SV2 uses the received information GIF, STIF to generate a configuration profile which is stored by the second server SV2.

How the configuration profile is generated is shown, substantially excepting obvious individual storage operations, in the change-of-state diagram in FIG. 8 by the transitions from a fifth SV2 status “Communication template KFV, for example XSLT (style sheet)” SV2Z5 (EXtensible Style Sheet Language Transformation) to a sixth SV2 status “Parameterizing” SV2Z6, and from the sixth SV2 status “Parameterizing” SV2Z6, taking account of the device and control information GIF, STIF (transitions of the EG statuses EGZ3, EGZ4 to the second server SV2) transmitted from the terminal EG to the second server SV2, to a seventh SV2 status “Communication profile KFP, for example XSLT (style sheet)” SV2Z7.

The configuration profile KFP is consequently the result of parameterizing the configuration template KFV by means of the device and control information GIF, STIF.

In a first follow-on status FZ1′ a service message SN arrives in the service center SZ1 . . . SZ5 for the user of the terminal EG. In a fifth flow phase AP5′ the service center SZ1 . . . SZ5 thereupon transmits the service message SN to the first server SV1 for example in accordance with the server/service center-specific transmission protocol SMTP, MM1 . . . MM7, which server forwards said message to the second server SV2. The received service message SN is analyzed and stored in the second server SV2. The second server SV then transmits a notification message MN to the terminal EG informing the terminal EG that a service message SN intended for the terminal EG is in the second server SV2 and can be collected. For this purpose the notification message MN contains a “Unified Resource Locator (URL)”.

This is also shown, substantially excepting obvious individual storage and forwarding operations, in the change-of-state diagram in the change-of-state diagram in FIG. 8 by the transitions from a second SZ status “Service message SN, for example SMS, MMS, e-mail, fax, voice mail, Instant Messaging etc.” SZZ2 to the second server SV2, from the second SZ status “Service message SN, for example SMS, MMS, e-mail, fax, voice mail, Instant Messaging etc.” SZZ2 to an eighth SV2 status “Analyzing and disassembling the service message” SV2Z8, from the eighth SV2 status “Analyzing and disassembling the service message” SV2Z8 to a ninth SV2 status “Structure information SIF, for example MPEG-7” SV2Z9, from the second SZ status “Service message SN, for example SMS, MMS, e-mail, fax, voice mail, Instant Messaging etc.” SZZ2 to a tenth SV2 status “Generating a notification” SV2Z10, from the third SV2 status “Storing the second communication system address” SVZ1 to the tenth SV2 status “Generating a notification” SV2Z10, and from the tenth SV2 status “Generating a notification” SV2Z10 to the fifth EG status “Notification message MN” EGZ5.

The service message stored in the second server SV2 is disassembled into its individual components during analyzing and disassembling in the eighth SV2 status SV2Z8 and the structure of the message and/or the semantic meaning of the individual components analyzed. The results of said analysis are then compiled into structure information SIF, preferably in MPEG-7 format, and stored. In parallel with the above-described analysis, a notification is generated in the tenth SV2 status SV2Z10 concerning the service message's arrival in the second server SV2, where applicable (as an additional option) also taking account of individual message content, after which the notification message MN is transmitted with the “Unified Resource Location (URL)” to the relevant terminal EG in accordance with the network address and second communication system address NAD, KSAD2 stored in the second server.

In a directly ensuing sixth flow phase AP6′ the terminal EG transmits a retrieval request AAF to the second server SV2 to collect the service message SN stored in the second server SV2. On receiving said retrieval request AAF the second server SV2 edits the stored service message SN for outputting and presenting the message content on the terminal EG and, for this purpose, produces a presentation message PN that is presented, for example, in different formats such as “HyperText Markup Language (HTML)”, “EXtensible Markup Language (XML)”, “WAP (Wireless Application Protocol) Markup Language (WML)” or “Synchronized Multimedia Integration Language (SMIL)” and which it transmits to the terminal EG in accordance with the server-/terminal-specific transmission protocol HTTP, SIP. After receiving the presentation message PN the terminal EG presents said presentation message PN acoustically, graphically, and/or optically.

This is also shown or, as the case may be, indicated, substantially excepting obvious individual storage operations, in the change-of-state diagram in FIG. 8 by the transitions from the fifth EG status “Notification message MN” EGZ5 to the sixth EG status “Retrieval request AAF” EGZ6, from the sixth EG status “Retrieval request AAF” EGZ6 to an eleventh SV2 status “Generating a presentation” SV2Z11, from the ninth SV2 status “Structure information SIF, for example MPEG-7” SV2Z9 to the eleventh SV2 status “Generating the presentation” SV2Z11, from the seventh SV2 status “Configuration profile KFP, for example XSLT (style sheet)” SV2Z7 to the eleventh SV2 status “Generating the presentation” SV2Z11, from the eleventh SV2 status “Generating a presentation” SV2Z11, taking account of the service message SN transmitted from the service center SZ1 . . . SZ5 to the second server SV2 (transition of the SZ status SZZ2 to the second server SV2) to the seventh EG status “Presentation message PN, for example HTML, XML, WML, SMIL etc.” EGZ7, and from the seventh EG status “Presentation message PN, for example HTML, XML, WML, SMIL etc.” EGZ7 to the eighth EG status “Presenting the presentation message, for example acoustically, graphically, and/or optically” EGZ8. When the terminal EG has transmitted the retrieval request AAF to the second server SV2 for collecting the service message SN, a presentation is generated in the eleventh SV2 status SV2Z11 from the stored service message SN by means of the configuration profile KFP and the structure information SIF, after which the presentation message PN is transmitted to the terminal EG, where said message is presented acoustically, graphically, and/or optically.

In a second follow-on status FZ2′ the user of the terminal EG wishes to send someone (for example a distant mobile radio subscriber) a service message SN. In a seventh flow phase AP7′ the user of the terminal EG first generates the content of said service message then inserts the generated content into the service message generating template SNEV received from the second server SV2 during the log-on phase. If the service message generating template SNEV is not available to the user at this time, which may certainly be the case if, as a possible alternative to the case shown in FIGS. 5a and 5b, the service message generating template SNEV has not been transmitted during the third flow phase AP3′ (log-on phase) of the terminal, then the service message generating template SNEV must be requested separately from the terminal EG. The completed service message generating template SNEV will be conveyed to the second server SV2 when the user has inserted the generated content into the service message generating template SNEV. In the seventh flow phase AP7′ the second server SV2 generates the service message SN from the conveyed service message generating template SNEV and transmits said message to the service center SZ1 . . . SZ5 for the purpose of conveying the message to the distant mobile radio subscriber.

This is also shown or, as the case may be, indicated, substantially excepting obvious individual storage operations, in the change-of-state diagram in FIG. 9 by the transitions from the ninth EG status “Message content generated by the user of the terminal” EGZ9 to the tenth EG status “Transferring the message content to the service message generating template, for example HTML, XML, WML, SMIL etc.” EGZ10, from the tenth EG status “Transferring the message content to the service message generating template, for example HTML, XML, WML, SMIL etc.” EGZ10, taking account of the service message generating template SNEV transmitted from the second server SV2 to the terminal EG (transition of the SV2 status SV2Z4 to the terminal) to the eleventh EG status “Completed service message generating template” EGZ11, from the eleventh EG status “Completed service message generating template” EGZ11 to a twelfth SV2 status “Producing the service message SN, for example SMS, MMS, e-mail, fax, voice mail, Instant Messaging etc.” SV2Z12, and from the twelfth SV2 status “Producing the service message SN, for example SMS, MMS, e-mail, fax, voice mail, Instant Messaging etc.” SV2Z12 to the third SZ status “Service message SN, for example SMS, MMS, e-mail, fax, voice mail, Instant Messaging etc.” SZZ3.

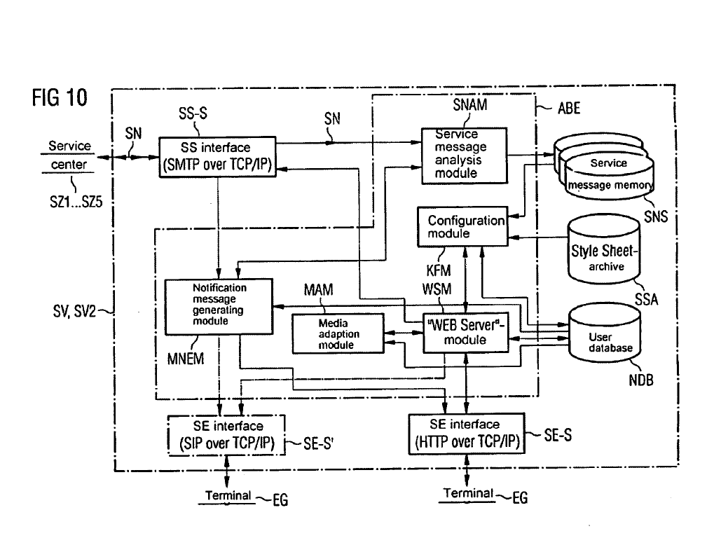

FIG. 10 shows the basic structure of the server SV in FIG. 1 and of the second server SV2 in FIGS. 2 and 3 for transmitting a service message SN on the downlink (service center→terminal). Besides the editing unit ABE already mentioned in the description of FIGS. 1 to 3, the service message memory SNS located in the server SV, SV2 and assigned to the editing unit ABE, and the user database NDB likewise located in the server SV, SV2 and assigned to the editing unit ABE, the server SV, SV2 accordingly also contains a server/service center interface (SS interface) SS-S and a server/terminal interface (SE interface) SE-S, SE-S′. The server SV, SV2 is connected via the SS interface SS-S to the service center SZ1 . . . SZ5 and via the SE interface SE-S, SE-S′ to the terminal EG. While the SS interface SS-S is designed for transmitting the service message SN in accordance with the transmission protocol SMTP, MM1 . . . MM7-over-TCP/IP, the SE interface SE-S is embodied for transmitting the presentation message PN, the notification message MN, and other information or, as the case may be, messages in accordance with the transmission protocol HTTP-over-TCP/IP. As an alternative to the SE interface SE-S it is, however, also possible to use the SE interface SE-S′ (this is indicated in FIG. 10 by the dot-and-dash lining), with the SE interface SE-S′ being embodied for transmitting the presentation message PN, the notification message MN, and other information or, as the case may be, messages in accordance with the transmission protocol SIP-over-TCP/IP.

The editing unit ABE contains a service message analyzing module SNAM and a notification message generating module MNEM, with the latter having an I connection (INPUT connection) to the service message analyzing module SNAM. Both the service message analyzing module SNAM and the notification message generating module MNEM moreover also have an I connection to the SS interface SS-S. The service message analyzing module SNAM also has an O connection (OUTPUT connection) to the service message memory SNS, while the notification message generating module MNEM also has an I connection to the user database NDB and an O connection to the SE interface SE-S, SE-S′. The transmitting and processing operations belonging to the flow phase AP4, AP5′ in FIGS. 4a and 5b are performed in the functional unit formed from the service message analyzing module SNAM, the service message memory SNS, the notification message generating module MNEM, the user database NDB, the SE interface SE-S, and the SS interface SS-S according to the representations shown in FIGS. 4a, 5b, 6, and 8.

The editing unit ABE furthermore has a configuration module KFM, a “style sheet” archive SSA, a “WEB server” module WSM, and a media adaption module MAM, with the configuration module KFM having an I connection to the service message memory SNS and “style sheet” archive SSA and an I/O connection (INPUT/OUTPUT connection) to the user database NDB and the “WEB server” module WSM, with the “WEB server” module WSM having, alongside the I/O connection to the configuration module KFM, in each case a further I/O connection to the user database NDB, the SE interface SE-S, and the media adaption module MAM, and an O connection to the SS interface SS-S, and with the media adaption module MAM having, alongside the I/O connection to the “WEB server” module WSM, an I connection to the user database NDB.

The transmitting and processing operations belonging to the flow phases AP1, AP1′, AP2, AP2′, AP3′ in FIGS. 4a and 5a are performed in the functional unit formed from the “WEB server” module WSM, the user database NDB, the SE interface SE-S, and the SS interface SS-S according to the representations shown in FIGS. 4a, 5a and 6 to 9.

The transmitting and processing operations belonging to the flow phases AP3, AP5, AP4′, AP6′ in FIGS. 4a, 4b, 5a, and 5b are performed in the functional unit formed from the configuration module KFM, the service message memory SNS, the “style sheet” archive SSA, the “WEB server” module WSM, the user database NDB, the media adaption module MAM, and the SE interface SE-S, SE-S′ according to the representations shown in FIGS. 4a, 4b, 5a, 5b, 6, and 8.

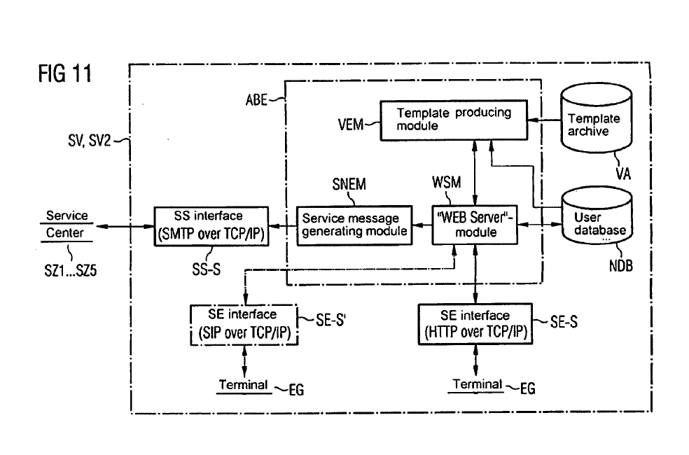

FIG. 11 shows the basic structure of the server SV in FIG. 1 and of the second server SV2 in FIGS. 2 and 3 for transmitting a service message SN on the uplink (terminal→service center). Besides the editing unit ABE already mentioned in the description of FIGS. 1 to 3, the service message memory SNS located in the server SV, SV2 and assigned to the editing unit ABE, and the user database NDB likewise located in the server SV, SV2 and assigned to the editing unit ABE, the server SV, SV2 accordingly also contains a server/service center interface (SS interface) SS-S and a server/terminal interface (SE interface) SE-S, SE-S′. The server SV, SV2 is connected via the SS interface SS-S to the service center SZ1 . . . SZ5 and via the SE interface SE-S, SE-S′ to the terminal EG. While the SS interface SS-S is designed for transmitting the service message SN in accordance with the transmission protocol SMTP, MM1 . . . MM7-over-TCP/IP, the SE interface SE-S is embodied for transmitting the presentation message PN, the notification message MN, and other information or, as the case may be, messages in accordance with the transmission protocol HTTP-over-TCP/IP. As an alternative to the SE interface SE-S it is, however, also possible to use the SE interface SE-S′ (this is indicated in FIG. 11 by the dot-and-dash lining), with the SE interface SE-S′ being embodied for transmitting the presentation message PN, the notification message MN, and other information or, as the case may be, messages in accordance with the transmission protocol SIP-over-TCP/IP.

Besides the “WEB server” module WSM and the user database NDB, the editing unit ABE contains a service message generating module SNEM, a template producing module VEM, and a template archive VA, with the “WEB server” module WSM having, alongside the I/O connection to the user database NDB and the SE interface SE-S, an O connection to the service message generating module SNEM and an I/O connection to the template producing module VEM, with the template producing module VEM having, alongside the I/O connection to the “WEB server” module WSM, an I connection to the user database NDB and the template archive VA, and with the service message generating module SNEM having, alongside the connection to the “WEB server” module WSM, an O connection to the SS interface SS-S.

The transmitting and processing operations belonging to the flow phases AP6, AP7′ in FIGS. 4b and 5b are performed in the functional unit formed from the “WEB server” module WSM, the user database NDB, the template archive VA, the service message generating module SNEM, the template producing module VEM, the SE interface SE-S, and the SS interface SS-S according to the representations shown in FIGS. 4b, 5b, 7, and 9.

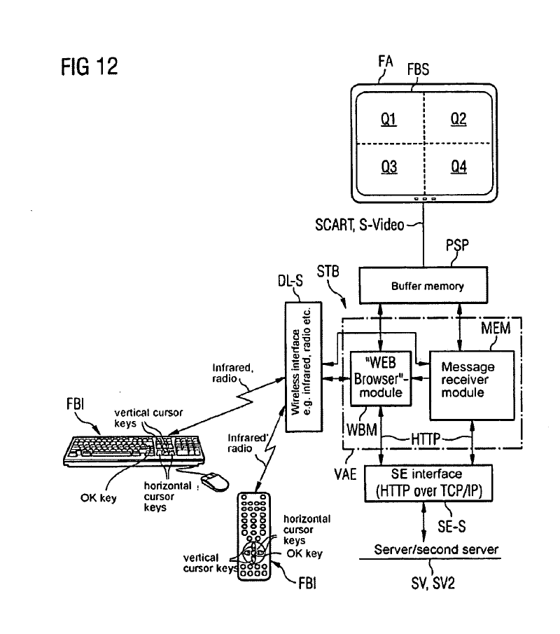

FIG. 12 shows the basic structure of the terminal EG embodied as a set-top box STB in conjunction with a television set FA, FBS and with a remote control instrument FBI. The central element of the terminal EG is the set-top box STB consisting substantially of a processing unit VAE, a buffer memory PSP, a wireless interface DL-S, and a server/terminal interface (SE interface) SE-S. The set-top box STB is connected to the server SV, SV2 according to FIGS. 10 and 11 via the SE interface SE-S, which is again designed for the transmission protocol HTTP-over-TCP/IP.

The wireless interface DL-S sets up the wireless connection, preferably embodied as an infrared or radio link, to the remote control instrument FBE, which can be embodied as, for example, a computer keyboard or a television remote control unit.

The buffer memory PSP serves to buffer the output data transmitted via a SCART or S-video interface to the television set FA having a television screen FBS.

The processing unit VAE of the set-top box STB contains a “WEB browser” module WBM and a message receiver module MEM embodied as a “listener” or, as the case may be, notification recipient. Both the “WEB browser” module WBM and the message receiver module MEM have in each case I/O connections to the buffer memory PSP, the SE interface SE-S, and the wireless interface DL-S. The “WEB browser” module WBM furthermore has an I connection to the message receiver module MEM.

For displaying the output data on the television screen this is subdivided into four quadrants Q1 . . . Q4. The content of a message archive is displayed in a first quadrant Q1 (top left on the screen). The television program in progress is displayed in a second quadrant Q2 (top right on the screen), while the respective message text or, as the case may be, current media element, for example an image or video, is displayed in a third quadrant Q3 (bottom left on the screen) and a fourth quadrant Q4 (bottom right on the screen).

The remote control instrument FBI has an OK key, for example for selecting a message, and in each case two vertical cursor keys (“top/up” and “bottom/down” arrow keys) and horizontal cursor keys (“left” and “right” arrow keys). The vertical cursor keys make it possible to navigate in the message archive while the horizontal keys are used to change between the individual quadrants Q1 . . . Q4. The OK key and cursor keys of the remote control instrument FBI can alternatively be embodied as softkeys.

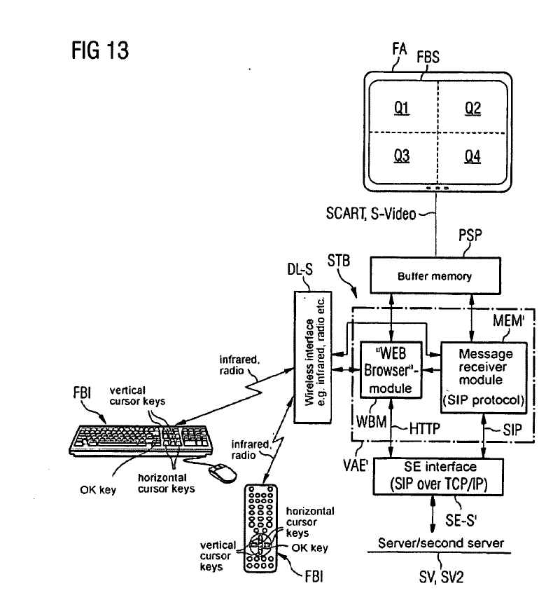

FIG. 13 shows the basic structure of the terminal EG embodied as a set-top box STB in conjunction with a television set FA, FBS and with a remote control instrument FBI wherein the data and messages requiring to be transmitted to the terminal can be transmitted with the aid of an SIP protocol. The central element of the terminal EG is again the set-top box STB consisting substantially of a processing unit VAE′ modified owing to the SIP protocol, the buffer memory PSP, the wireless interface DL-S, and a modified server/terminal interface (SE interface) SE-S′. The set-top box STB is connected to the server SV, SV2 according to FIGS. 10 and 11 via the SE interface SE-S′ which, in contrast to the SE interface shown in FIG. 12, is designed for the transmission protocol SIP-over-TCP/IP.

The wireless interface DL-S again sets up the wireless connection, preferably embodied as an infrared or radio link, to the remote control instrument FBE, which can be embodied as, for example, a computer keyboard or a television remote control unit.

The buffer memory PSP again serves to buffer the output data transmitted via a SCART or S-video interface to the television set FA having a television screen FBS.

The processing unit VAE of the set-top box STB again contains a “WEB browser” module WBM and a modified message receiver module MEM′ embodied as a “listener” or, as the case may be, notification recipient. Both the “WEB browser” module WBM and the message receiver module MEM′ again have in each case I/O connections to the buffer memory PSP, the SE interface SE-S, and the wireless interface DL-S. The “WEB browser” module WBM furthermore has an I connection to the message receiver module MEM′.

For displaying the output data on the television screen this is again subdivided into four quadrants Q1 . . . Q4. The content of a message archive is displayed in a first quadrant Q1 (top left on the screen). The television program in progress is displayed in a second quadrant Q2 (top right on the screen), while the respective message text or, as the case may be, current media element, for example an image or video, is displayed in a third quadrant Q3 (bottom left on the screen) and a fourth quadrant Q4 (bottom right on the screen).

The remote control instrument FBI again has an OK key, for example for selecting a message, and in each case two vertical cursor keys (“top/up” and “bottom/down” arrow keys) and horizontal cursor keys (“left” and “right” arrow keys). The vertical cursor keys make it possible to navigate in the message archive while the horizontal keys are used to change between the individual quadrants Q1 . . . Q4. The OK key and cursor keys of the remote control instrument FBI can alternatively be embodied as softkeys.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-74. (canceled)

75. A method for transmitting service messages in a network, the method comprising the steps of:
registering a terminal having a network system address with a server;
receiving terminal device information and control information for server-side configuring of the communication system, including a communication system address for the terminal;
accepting a service message at the server from a service center in accordance with a predetermined transmission protocol;
performing terminal-specific configuration at the server using the terminal device information and control information to generate a terminal-specific configuration template and terminal-specific parameterized configuration profile;
disassembling the service message into individual components, and analyzing the structure of the components to obtain formatted structure information;
identifying the addressee of the service message and sending a notification message to the identified addressee of the received service message with an addressing scheme for collecting the content of the service message;
transmitting the content of the service message from the server to the terminal by means of a retrieval request conveyed to the server; and
producing an audio/visual presentation message, based on a pre-specified presentation format, from the service message using the formatted structure information and the terminal-specific configuration profile, and conveys said presentation message to the terminal.

76. The method according to claim 75, wherein the terminal generates a message content for a further service message intended for a subscriber in the network, further comprising:
producing a service message generating template at the server using the device information based on a predetermined presentation format, for generating the further service message, and transmits said service message generating template to the terminal;
forwarding the generated message content to the received service message generating template and transmitting the service message generating template, augmented with the message content, to the server in accordance with a predetermined transmission protocol;
generating the further service message from the service message generating template furnished with the message content and transmitting the further service message intended for the subscriber in the network to the service center.

77. The method according to claim 75, wherein at least one of the server connections is a “Transmission Control Protocol/Internet Protocol (TCP/IP)” connection.

78. The method according to claim 75, wherein one of a telephone number, an e-mail address, a “Session Initiation Protocol (SIP)” and a “Universal Resource Identifier (URI)” is used as the network address and an IP address is used as the communication system address.

79. The method according to claim 75, wherein the terminal comprises one of a set-top box (STB), a smart telephone (STF), a “Personal Digital Assistant” (PDA), a cordless base station (BS), a personal computer (PC).

80. The method according to claim 79 wherein the terminal further comprises a universal interface to the packet-oriented connection via which the terminals are connected in accordance with a packet-oriented short-range radio or line-linked connection protocol either directly to the server or indirectly to the server by the base station or set-top box.

81. The method according to claim 75, wherein the device information indicates the type, characteristics, or features of the terminal (EG).

82. The method according to claim 75, wherein the control information comprises a password, the type and scope of a notification message (MN), a personal profile of the terminal user and/or personal preferences of the terminal user.

83. The method according to claim 75, wherein a “Simple Mail Transfer Protocol (SMTP)” is used as the protocol between the server and service center and a “HyperText Transfer Protocol (HTTP)” or “Session Initiation Protocol (SIP)” is used as the protocol between the server and terminal.

84. The method according to claim 75, wherein one of a “HyperText Markup Language (HTML)”, an “EXtensible Markup Language (XML)”, a “WAP (Wireless Application Protocol) Markup Language (WML)” and a “Synchronized Multimedia Integration Language (SMIL)” is used as the presentation format for the presentation message and the service message generating template.

85. The method according to claim 75, wherein an “EXtensible Style Sheet Language Transformation (XSLT) is used for generating the configuration profile.

86. The method according to claim 75, wherein registering of the terminal with the server is performed offline directly with the operator of the server by entering the network-specific network address on the server or by registering and logging on via WEB forms, with the server keeping track of a current status by registering a legitimacy, along with a terminal user's personal profile, a terminal type and characteristics, and storing the terminal user's personal preferences in terms of presenting and interacting.

87. The method according to claim 75, wherein the protocol between the server and the service center comprises one of:
a “Multimedia Message Service Center (MMSC)” forwarding a MMS-specific “Protocol Data Unit (PDU)” to the server,
a “Short Message Service Center (MMSC)” forwards a SMS-specific “Protocol Data Unit (PDU)” to the server,
an “Instant Messaging Service Center (IMSC)” forwards “instant messages” to the server using an SIP redirector,
an “Electronic Mail Service Center (EMaiISC)” forwards e-mails to the server, and
a “Voice Mail Service Center (VMailSC)” which accepts voice mails as e-mails or, as a gateway, accepts calls and forwards them to the server as e-mails or SIP messages.

88. The method according to claim 75, wherein an editing unit of the server further accepts attachments to the message content of the service message and converts them into a graphic format supported by the terminal, with said editing unit recognizing the files added as an attachment from the respective ending of the ID code, executing a suitable processing program for the respective file type to incorporate a device driver for output in a specific graphic format, and, via said program, converting the respective file into a suitable format for the terminal.

89. The method according to claim 75, wherein the structure information obtained from the analysis is processed to form a compilation, where the modality of media is converted into a series of related individual files.

90. The method according to claim 89, wherein the media is analyzed in terms of secondary information comprising at least one of author identification, the time of the recording and place of the recording, and wherein metadata generated during said analysis is assigned to the structure information.

91. The method according to claim 90, wherein the structure information is a MPEG-7 format.

92. The method according to claim 75, wherein the notification message is transmitted to the server during of after a time period where the terminal is logging on to the server.

93. The method according to claim 75, wherein the notification message is transmitted to the server during a time period where the presentation message is retrieved from the notification message.

94. The method according to claim 75, wherein the terminal comprises a set-top box communicatively coupled to a television set, and wherein the notification message is transmitted directly during the television program in progress.

95. The method according to claim 94, wherein the notification message already contains elements of the service message and is in the form of an instant message.

96. The method according to claim 94, wherein when the notification message is presented on a television screen, the television program in progress will automatically be recorded in the manner of time-shifted viewing then resumed without interruption on the screen when the notification has been acknowledged.

97. The method according to claim 96, wherein the display of the presentation message and notification message on the television screen is subdivided into 4 quadrants, with the content of the message archive being displayed in a first quadrant and the television program in progress being displayed in a second quadrant, while the respective message and current media being respectively displayed in a third and a fourth quadrant.

98. The method according to claim 97, wherein the set-top box is assigned cursor keys with said cursor keys being used to navigate and select messages in a message archive, and to change views between the quadrants.

99. The method according to claim 98, wherein a television remote control unit or a computer keyboard is used as the remote control instrument.

100. The method according to claim 75, wherein, if the session is interrupted, the server will keep track of the status of message retrieving through transmitting of the retrieval request by the terminal by storing the status so that the session can be resumed at a later time.

101. A method for transmitting service messages in a network, comprising:
registering a terminal having a communication system address with a server;
receiving a message content for a service message from a terminal intended for a subscriber in the network;
receiving terminal device information and control information for server-side configuring of the communication system;
receiving a service message at the server from a service center in accordance with a predetermined transmission protocol;
performing terminal-specific configuration at the server using the terminal device information and control information to generate a service message generating template, based on a predetermined presentation format for generating the service message;
transmitting said service message generating template to the terminal;
combining the generated message content with the service message generating template using a pre-specified server-/terminal-specific transmission protocol;
generating a service message at the server using the combined service message generating template and message content; and
transmitting the service message intended for the subscriber to the service center.

102. A method for transmitting service messages from a service center located in a network comprising the steps of:
forming a first communication system comprising:
connecting a first server via a packet-switched first connection to the service center; and
connecting the first server via a packet-switched second connection to a second server;
forming a second communication system comprising the second server connected via a packet-switched third connection to a terminal;
registering a network-specific network address of the second server with the first server and forwarding the network-specific network address of the second server to the service center;
receiving a service message from the service center in accordance with a pre-specified server/service center-specific transmission protocol in the first server and forwarding the service message to the second server;
logging the terminal to the second server and transmitting terminal device information and control information alongside a second communication system address for server-side configuration;
performing terminal-specific configuration in the second server using the terminal device information and by means of the control information and terminal-specific configuration templates stored in the second server to generate a terminal-specifically parameterized configuration profile
disassembling the service message which has been received from the first server in the second server and analyzing the individual components of the disassembled service message to determine a message structure;
storing the analyzed message as formatted structure information;
identifying the addressee of the service message, and sending a notification message to the identified addressee of the received service message along with an addressing scheme for collecting the content of the service message stored on the second server;
retrieving the content of the service message stored on the second server by means of a retrieval request conveyed from the terminal to the second server in accordance with the addressing scheme in the notification message;
producing a presentation message at the second server, based on a pre-specified presentation format, using the service message and the formatted structure information and the terminal-specific configuration profile on the basis of the received retrieval request; and
transmitting the presentation message to the terminal in the form of an audio/visual message.

103. The method according to claim 102, wherein the second server is integrated in the terminal for forming a structural and functional unit.

104. The method according to claim 103 wherein the terminal generates a message content of a further service message intended for a subscriber in the network, further comprising:
producing a service message generating template in the second server, based on a pre-specified presentation format, for generating the further service message, and transmitting said service message generating template to the terminal using the device information;
transferring the generated message content from the terminal using the received service message generating template and transmitting the service message generating template along with the message content, to the second server in accordance with a predetermined server-/terminal-specific transmission protocol;
generating the further service message at the second server using the service message generating template furnished with the message content and transmitting said further service message intended for the subscriber to the first server, which forwards said service message to the service center.

105. The method according to claim 102, wherein the retrieved presentation message is outputted in the terminal by means of a processing unit having an installed web browser module.

106. The method according to claim 105, wherein the processing unit of the terminal is assigned a message receiver module that opens a TCP/IP port in order to receive the notification message and which controls outputting of the notification message and the we browser module.

107. The method according to claim 106, wherein the message receiver module of the terminal is assigned an SIP client functionality by means of which the terminal registers with and logs on to the server in accordance with a Session Initiation Protocol and receives the notification message as an SIP message.

108. The method according to claim 102 wherein the service message generating template is compiled from a form or from an applet that can be executed on the terminal and an augmenting template, and wherein the template is completed during editing by the user of the terminal controlled by a WEB form.

109. A method for transmitting service messages in a network wherein a terminal generates a message content of a service message intended for a subscriber in the network, comprising the steps of:
forming a first communication system comprising:
connecting a first server via a packet-switched first connection to a service center; and
connecting the first server via a packet-switched second connection to a second server;
forming a second communication system comprising the second server connected via a packet-switched third connection to a terminal;
registering a network-specific network address of the second server with the first server and forwarding the network-specific network address of the second server to the service center;
logging the second server to the first server and forwarding a first communication system address to the first server;
logging the terminal to the second server and forwarding terminal device information and a second communication system address to the second server;
using the device information, the second server producing a service message generating template, based on a predetermined presentation format for generating the service message, and forwarding the service message generating template to the terminal;
transferring the generated message content from the terminal using the received service message generating template and forwarding the service message generating template, augmented with the message content, to the second server in accordance with a predetermined transmission protocol between the server and terminal; and
generating the service message from the service message generating template furnished with the message content at the second server and transmitting the service message intended for the to the first server, which forwards the service message to the service center.

110. The method according to claim 109, wherein the second server is integrated in the terminal for forming a structural and functional unit.

111. A server for transmitting service messages in a network wherein a service message intended for a terminal as the addressee is available in a service center, comprising:
a service center/server interface (“SE Interface”) comprising a packet-switched first connection;
a server/terminal interface (“SS Interface”) comprising a packet-switched second connection, wherein the terminal and the server form a communication system;
an editing unit that controls the system communication of the communication system and is connected to the SE interface and a user database, wherein the SE interface, user database, and editing unit are configured such that a network-specific network address of the terminal is registered with the server and the editing unit, and is forwarded to the service center by the editing unit and stored in the user database;
wherein the SE interface is further configured such that, alongside a communication system address notified by the terminal registered with the server, the SE interface transmits to the editing unit device information and control information notified by the terminal for server-side configuring of the communication system and system communication;
wherein the SS interface is configured such that it accepts the service message from the service center in accordance with a pre-specified server/service center-specific transmission protocol;
wherein the editing unit is configured such that that server-side configuring of specific terminals comprises terminal-specific configuration templates stored in a style sheet archive and is performed using the device information and by means of the control information to generate a terminal-specifically parameterized configuration profile;
wherein the editing unit, the SE interface, and the SS interface are configured such that the service message accepted from the service center is stored in a service message memory, and the service message accepted from the service center is disassembled into its individual components, its structure analyzed, and the results obtained are stored as formatted structure information, the addressee of the service message is identified, and a notification message is sent via the SE interface to the identified addressee to provide notification of the received service message with an addressing scheme for collecting the content of the service message stored on the server;
wherein the SE interface is configured such that a retrieval request transmitted from the terminal, with which request the terminal retrieves the content of the stored service message from the server according to the addressing scheme in the notification message, is forwarded to the editing unit; and
wherein the editing unit is configured such that a presentation message based on a predetermined presentation format is produced from the service message by reason of the received retrieval request using the formatted structure information and the terminal-specific configuration profile, and said presentation message is transmitted via the SE interface to the terminal, where the received presentation message is presented as an audio/visual message.
